(19) United States
(12) Patent Application Publication
(10) Pub. No.: US 2017/0106435 A1
(43) Pub. Date: Apr. 20, 2017

(54) CASTER TIP FOR A CONTINUOUS CASTING PROCESS

(71) Applicant: Pyrotek Engineering Materials Limited, Milton Keynes (GB)

(72) Inventor: Mark VINCENT, Bedfordshire (GB)

(21) Appl. No.: 15/260,795

(22) Filed: Sep. 9, 2016

(30) Foreign Application Priority Data
Oct. 20, 2015 (GB) 1518503.6
May 19, 2016 (GB) 1608805.6

(51) Int. Cl. B22D 11/06; H05B 3/02; H05B 3/00; B22D 11/103

(52) U.S. Cl. CPC B22D 11/0642; B22D 11/0622; B22D 11/103; H05B 3/026; H05B 3/0014

(57) ABSTRACT

A caster tip for a twin roll continuous strip caster for non-ferrous metals. The caster tip includes a caster tip body made primarily of a ceramic material, and an electric resistance heater thermally connected to the caster tip body for pre-heating the caster tip body to a predetermined temperature.

### RELATED APPLICATIONS

This application claims priority to Great Britain Patent Application No. 1518503.6, filed Oct. 20, 2015; and Great Britain Patent Application No. 1608805.6, filed May 19, 2016, the entire contents of which are incorporated herein by reference.

### TECHNICAL FIELD

The present invention relates to a caster tip for use in a continuous casting process. In particular but not exclusively the invention relates to a caster tip for a twin roll continuous strip caster that is used for casting non-ferrous metals, for example aluminium. The invention also relates to a continuous strip caster for non-ferrous metals, and in particular but not exclusively to a twin roll continuous strip caster.

### BACKGROUND

In a typical twin roll caster a liquid metal, for example aluminium, is fed from an elongate casting tip (or “discharge nozzle”) into the nip between two counter-rotating water cooled rollers. The liquid metal is cooled on contact with the rollers and freezes as it passes between the rollers to form a wide cast metal strip of uniform thickness. The casting process can operate continuously for as long as liquid metal is supplied to the caster.

Caster tips are typically made of a low density ceramic material that is able to withstand abrasion and thermal shock associated with liquid aluminium contact, for example a ceramic fibre board formed to the necessary shape. Because these materials are low in density they have a low thermal conductivity (typically less than 0.18 W/mK) and offer some degree of thermal insulation to the liquid Aluminium inside the caster tip. However, they can become chemically attacked and abraded after a period of production time. This can lead to the formation of various impurities within the tip structure ultimately leading to a premature stop of the casting campaign.

The thermal profile of the liquid metal exiting the caster tip ideally needs to be as uniform as possible along the caster tip length. The width of a caster tip can be anywhere from 0.3 m up to 2.5 m. Often the liquid metal exiting the caster tip is at its hottest in the central region and at the two outer ends of the tip as these are heavily insulated. The cooler regions are generally located to the left and right of the central region, between the central region and the end regions of the caster tip. These temperature differences can affect the uniformity of the casting process and the quality of the cast metal strip.

It is known to preheat the caster tip to the temperature of the liquid metal before delivering the metal to the caster tip. For example, U.S. Pat. No. 5,697,425 describes a continuous casting method in which a caster tip (or “discharge nozzle”) made of alumina graphite is preheated using an electric induction heating system.

U.S. Pat. No. 4,602,668 describes a nozzle for a block or caterpillar track type continuous strip caster, which includes heating elements for heating the nozzle in different locations to prevent bending and rubbing of the nozzle on a pair of mould belts. The nozzle includes ceramic tubes for delivering molten metal, connected together by metal supports.

U.S. Pat. No. 4,290,477 describes another nozzle for a block or caterpillar track type continuous strip caster, comprising hollow refractory sections held together by a metal frame. Electrical heating elements are accommodated within longitudinal channels between the refractory sections.

CN 102671947A describes another casting device for casting magnesium alloy in which a caster tip (or “pouring spout”) made of cast iron is heated with electric heating wires located within the pouring spout.

It is an object of the present invention to provide a caster tip that overcomes one or more of the aforesaid problems, or at least to provide a useful alternative to existing products.

### SUMMARY

More specifically, but not exclusively, it is an object of the invention to provide a solution to the problems associated with the formation of impurities within the caster tip and the temperature regulation of liquid metal as it passes through the caster tip.

According to a first embodiment of the invention there is provided a caster tip for a continuous strip caster for casting non-ferrous metals, wherein the caster tip comprises a caster tip body made of a ceramic material, and an electric resistance heater that is thermally connected to the caster tip body for pre-heating the caster tip body to a predetermined temperature.

The phrase “wherein the caster tip comprises a caster tip body made of a ceramic material” as used herein means that the majority of the structure of the caster tip body is made of a ceramic material. The caster tip body may however also include some other materials including, for example, some higher thermal conductivity materials designed to enhance the transfer of heat through caster tip body. In a preferred embodiment, the ceramic material constitutes at least 70% of the volume of the caster tip body, preferably at least 80%, more preferably at least 90%.

The reference to the electric resistance heater that being thermally connected to the caster tip body means in this context that the electric resistance heater is configured to transfer heat to the caster tip body by thermal conduction and/or by thermal radiation. In most cases the electric resistance heater will be arranged in thermal contact with the caster tip body so that the primary route of heat transfer is by thermal conduction. However, heat may also be transferred from the electric resistance heater to the caster tip body by thermal radiation, either solely or in combination with thermal conduction.

Because ceramic materials generally have a relatively low thermal conductivity, heat will be lost only slowly from the liquid metal as it passes through the caster tip, thus reducing the risk of metal solidifying within the caster tip. The flow of metal through the caster tip is therefore improved, providing a higher quality of cast strip metal product.

The provision of an electric resistance heater that is thermally connected to the caster tip body, which can be used to pre-heat the caster tip body to a predetermined temperature, also helps to avoid excessive cooling of the liquid metal when it first encounters the caster tip, which further enhances operation of the caster tip as described above.

Although the caster tip is designed primarily for use with a twin roll caster, it may also be useful with other types of continuous strip caster, for example belt casters, block casters or wheel and belt casters, some examples of which are disclosed in U.S. Pat. No. 5,799,720.

In an embodiment the caster tip body has an upper surface and a lower surface, and the electric resistance heater is located on and in thermal contact with at least one of the upper and lower surfaces.

In an embodiment the electric resistance heater covers at least 30% of the area of said upper and/or lower surface, preferably at least 40, more preferably at least 50%.

In an embodiment the caster tip body has a width and the electric resistance heater extends across substantially the entire width of the caster tip body. For example, the electric resistance heater may extend across at least 70% of the width of the caster tip body, preferably at least 80%, more preferably at least 90%.

The electric resistance heater may comprise at least one heater panel that includes an electric heating element embedded in a support panel. Generally, a plurality of heater panels will be provided for heating the caster tip body. The support panel both supports and protects the electric heating element, and helps to ensure an efficient transfer of heat to the caster tip body. This modular form of electric heater also makes handling and assembly of the caster tip simpler and more convenient, and allows the heater panels to be re-used if the caster tip body has to be removed or replaced. The heater panel is preferably substantially flat (planar).

The support panel may comprise a ceramic fibre board or a non-ceramic fibre board. For example, the support panel may be made of a low density ceramic fibre board or non-ceramic fibre board, which may include refractory ceramic fibre (RCF) reinforcing fibres or bio-soluble non-RCF reinforcing fibres.

The caster tip body may include at least one recess that receives a heater panel. For example, the caster tip body may include a plurality of recesses, each of which receives a separate heater panel. The provision of recesses that receive the heater panels helps to ensure an efficient transfer of heat from the heater panels to the caster tip body. The recess or recesses are preferably provided in an upper and/or lower surface of the caster strip body.

Alternatively, the electric resistance heater may comprise an electric heating element that is embedded within the ceramic material of the caster tip body, or that is accommodated within a groove formed in a surface of the caster tip body. These arrangements ensure direction transfer of heat by thermal conduction from the electric resistance heater to the caster tip body. In addition, as the electrical resistance heater is embedded or accommodated in a groove in the ceramic caster tip body, it is possible to provide a heater without increasing the dimensions of the caster tip body.

In an embodiment the caster tip body is made primarily of a cast fibrous ceramic material, which may be based on fused silica. The caster tip body may for example be made primarily of a cast fibrous ceramic material that includes fused silica, ceramic fibre, microsilica and a bonding material comprising colloidal silica. Such a material is described in GB1407343.1, the contents are which are incorporated by reference herein.

Alternatively, the caster tip body may be made primarily from a cement-bonded fused silica refractory material or a silicon carbide (SiC) based material or a material that is based on a combination of fused silica and SiC, optionally with the addition of silicon nitride (Si₃N₄) or Magnesium Oxide (MgO) powder for enhanced thermal conductivity in any of the combinations described.

In an embodiment the caster tip body is made primarily of a ceramic material that has a thermal conductivity at a temperature of 700 C in the range 0.1-30 W/mK, preferably 1-20 W/mK, more preferably 1-15 W/mK.

The caster tip body may include at least one thermal conductor element having a thermal conductivity greater than that of the ceramic material. The thermal conductor element may have a thermal conductivity at a temperature of 700 C of more than 1 W/mK, preferably more than 20 W/mK. For example, the caster tip body may include one or more inserts made of graphite or a similar material, which has a thermal conductivity at a temperature of 700 C of about 40-70 W/mK. The inserts are preferably embedded within the ceramic material so that they are isolated from contact with the liquid metal. The thermal conductor elements help to enhance the flow of heat from the electrical resistance heater to the liquid metal within the caster tip, thereby helping to maintain the metal at the required casting temperature.

An embodiment of the invention relates to a caster tip for use in casting aluminium, wherein the predetermined temperature is in the range 600-750 C, preferably 680-750 C.

In an embodiment, the caster tip body comprises a top plate and a bottom plate, the top and bottom plates being spaced from one another to provide a feed slot for liquid metal at a front edge of the caster tip body, an inlet port for liquid metal at a rear end of the caster tip body.

The caster tip body may also include a baffle structure between the top and bottom plates for distributing a flow of liquid metal from the inlet port to the feed slot.

In an embodiment, the front edge of the castor tip body is tapered to fit between a pair of counter-rotating rolls in a twin roll caster.

In one form of the invention the caster tip body comprises monolithic cast structure that includes the top plate, the bottom plate and the baffle structure. This provides for increased strength and improved handling of the caster tip. In another form of the invention the caster tip body comprises an assembly of separate cast structures including the top plate and the bottom plate, and optionally the baffle structure.

In an embodiment, at least one electric resistance heater is thermally connected to the top plate and/or the bottom plate of the caster tip body. The caster tip body may include at least one recess in an upper surface of the top plate or a lower surface of the bottom plate that receives a heater panel. The caster tip body may include a plurality of recesses in the upper surface of the top plate and the lower surface of the bottom plate, wherein each recess receives a separate heater panel. Alternatively, at least one electric resistance heater may be embedded within the caster tip body, or accommodated within a groove in the caster tip body.

According to another aspect of the invention there is provided a continuous strip caster for non-ferrous metals, the strip caster including a pair of counter-rotating casting elements and a caster tip as defined in one of the statements of invention that is located adjacent a nip between the casting elements and configured to feed liquid metal into the nip to form a cast strip of metal.

The counter-rotating casting elements may comprise a pair of counter-rotating rolls, the caster tip being located adjacent a nip between the rolls. Preferably, the casting tip is located just in front of the nip so that liquid metal leaving the casting tip is carried into the nip by rotation of the rolls.

Optionally, the twin roll continuous strip caster may include one or more features of the caster tip as specified in any one of the preceding statements of invention.

Various embodiments of the invention will now be described by way of example with reference to the accompanying drawings.

### BRIEF DESCRIPTION OF THE DRAWINGS

FIG. 1 is an isometric view of a twin roll caster that includes a first caster tip according to an embodiment of the invention,

FIG. 2 is an end view of the twin roll caster shown in FIG. 1,

FIG. 3 is a rear view of the twin roll caster,

FIG. 4 is a top plan view of the twin roll caster,

FIG. 5 is a cross-section on line F-F of FIG. 4,

FIG. 6 is an isometric front view of the caster tip that forms part of the twin roll caster shown in FIGS. 1 to 5,

FIG. 7 is an isometric rear left view of the caster tip shown in FIG. 6,

FIG. 8 is an isometric rear right view of the caster tip,

FIG. 9 is a right hand end view of the caster tip,

FIG. 10 is a rear view of the caster tip,

FIG. 11 is a top plan view of the caster tip,

FIG. 12 is a rear sectional view on line C-C of FIG. 11, showing an internal baffle structure of the caster tip,

FIG. 13 is a side sectional view on line D-D of FIG. 11, showing the internal baffle structure,

FIG. 14 is an isometric rear view of the caster tip with the top part of the caster tip is removed to show the internal baffle structure,

FIG. 15 is a right rear isometric view of a top plate comprising part of a second caster tip according to an embodiment of the invention,

FIG. 16 is a left rear isometric view of the top plate shown in FIG. 15,

FIG. 17 is a right hand end view of the top plate,

FIG. 18 is a top plan view of the top plate,

FIG. 19 is a rear sectional view on line E-E of FIG. 18,

FIG. 20 is a side sectional view on line G-G of FIG. 18,

FIG. 21 is a top plan view of a bottom plate comprising part of the second caster tip,

FIG. 22 is a cross-section on line B-B of FIG. 21, showing an optional thermally conductive insert,

FIG. 23 is a right rear isometric view of a third caster tip according to an embodiment of the invention,

FIG. 24 is a right rear isometric view of the third caster tip, showing some internal details,

FIG. 25 is a right rear isometric view of a modified form of the third caster tip, showing some internal details,

FIG. 26 is a right rear isometric view of a fourth caster tip according to an embodiment of the invention, and

FIG. 27 is a right rear isometric view of a modified form of the fourth caster tip.

### DETAILED DESCRIPTION OF THE PREFERRED EMBODIMENTS

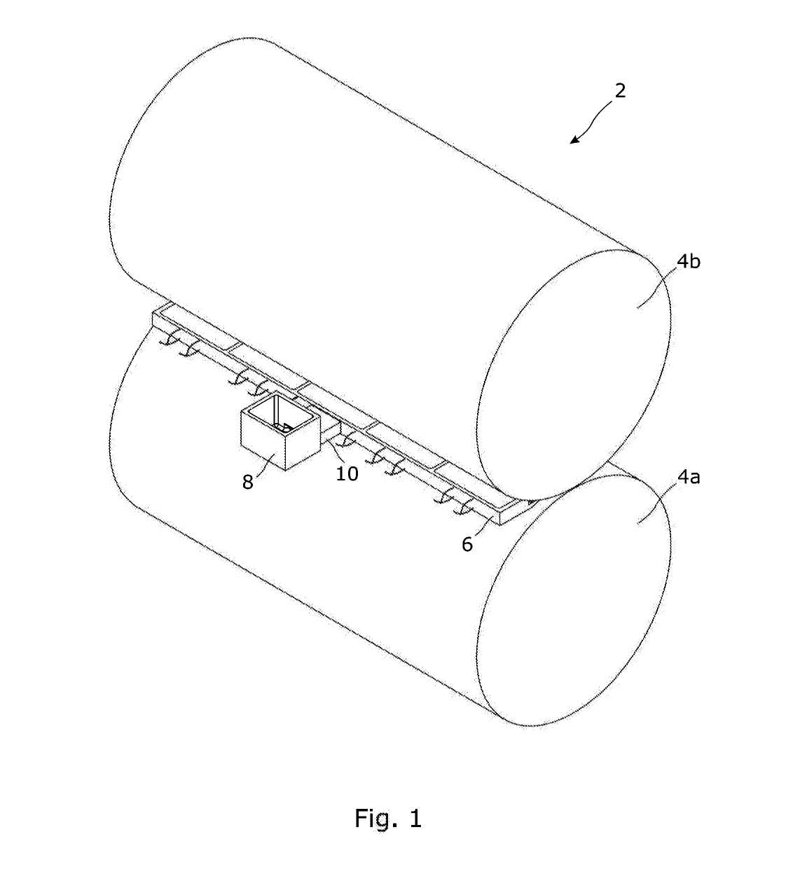

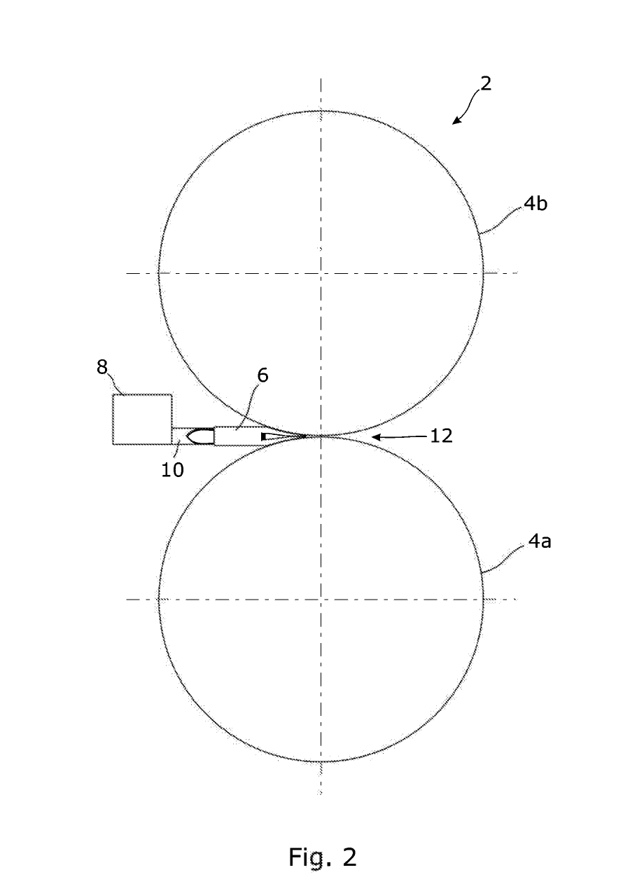

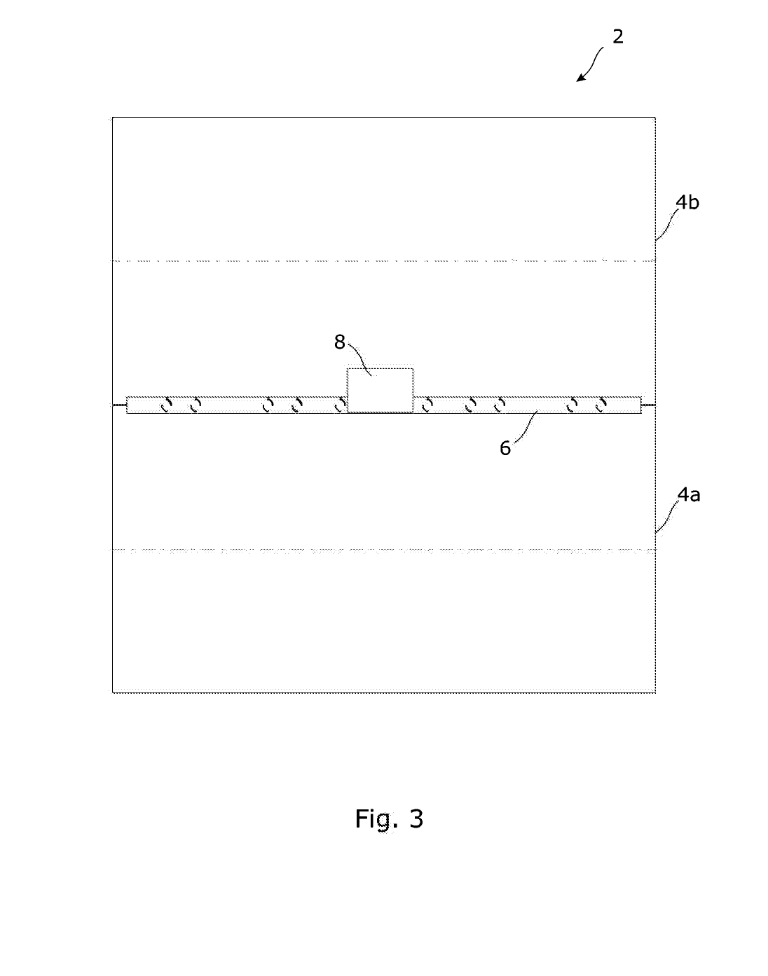

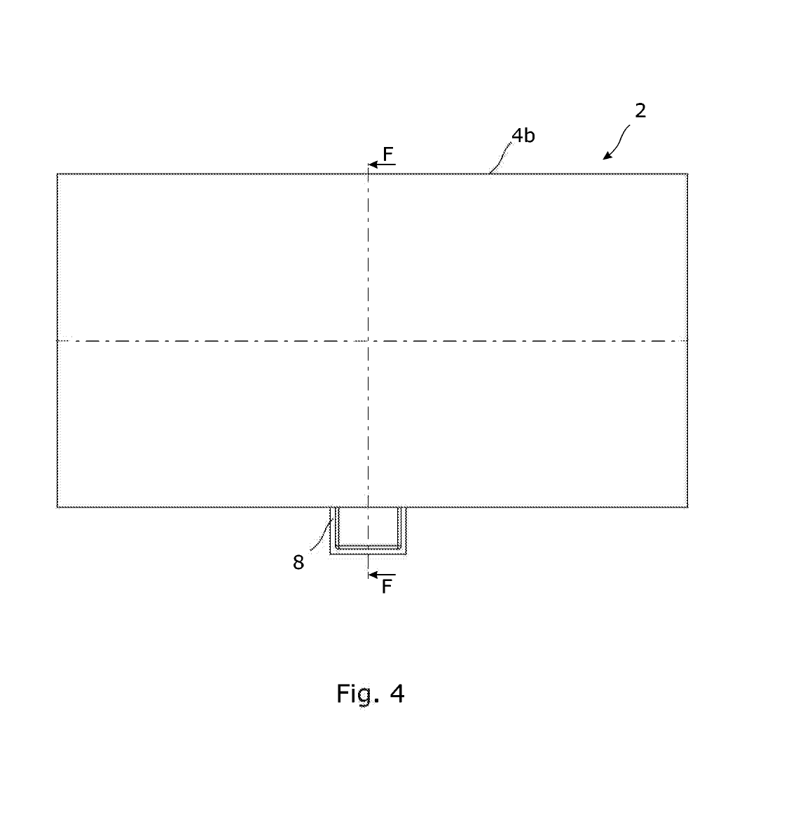

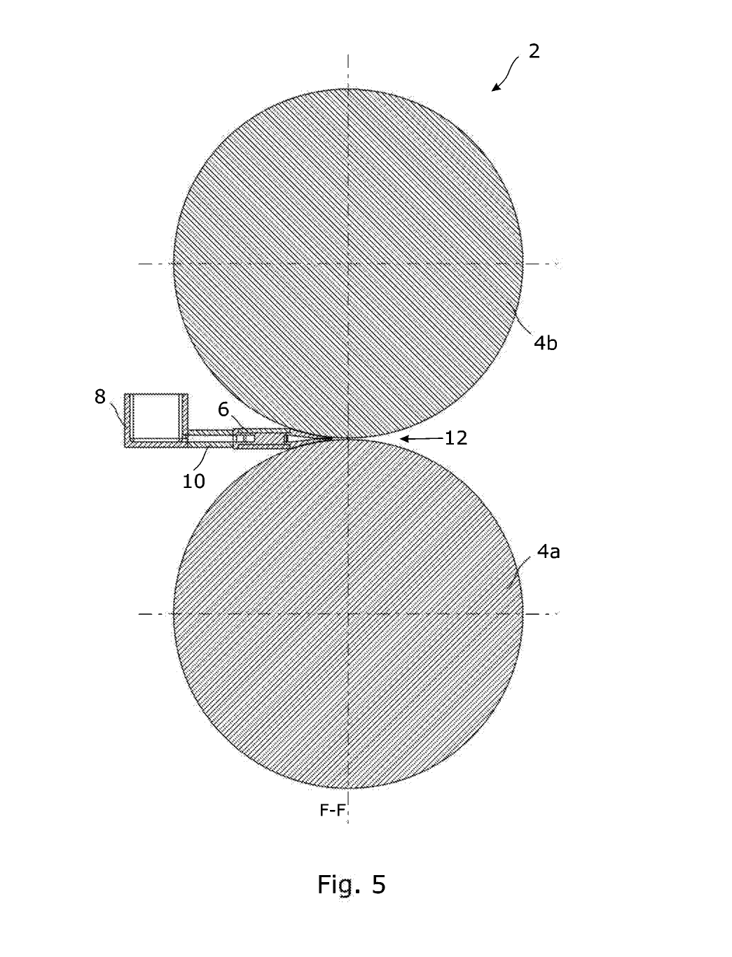

FIGS. 1-5 illustrate some of the key components of a twin roll caster 2 that includes a pair of counter-rotating, water cooled rolls 4a, 4b and a caster tip 6 according to a first embodiment of the invention. The caster tip 6 is positioned adjacent to the nip between the rolls 4a, 4b and is connected to a holding box 8 for holding liquid metal by a connecting tube 10 that delivers liquid metal from the holding box 8 to the caster tip 6. The twin roll caster 2 may also include other components for heating, treating and feeding liquid metal to the holding box 8, and for transporting and processing a strip of cast metal as it emerges from between the rolls 4a, 4b. However, these additional components are conventional and so will not be described. The twin roll caster 2 described herein is intended primarily, but not exclusively, for casting non-ferrous metals, in particular aluminium, which is typically cast at a temperature of about 700-750 C.

In the arrangement illustrated in FIGS. 1, 2 and 5, the lower roll 4a rotates clockwise and the upper roll 4b rotates anticlockwise. At the nip 12 between the rolls 4a, 4b, the rolls are separated from each other to provide a narrow gap, typically with a height of a few millimetres, which determines the thickness of the strip of metal produced by the caster.

The caster tip 6 is positioned to deliver liquid metal into the nip 12 between the rolls 4a, 4b. As the metal enters the nip 12 it is cooled by contact with the rolls 4a, 4b, which are water cooled. This causes the metal to freeze. The metal is drawn continuously through the nip 12 by the rotating rolls and is rolled to produce a wide strip of cast metal with a uniform thickness.

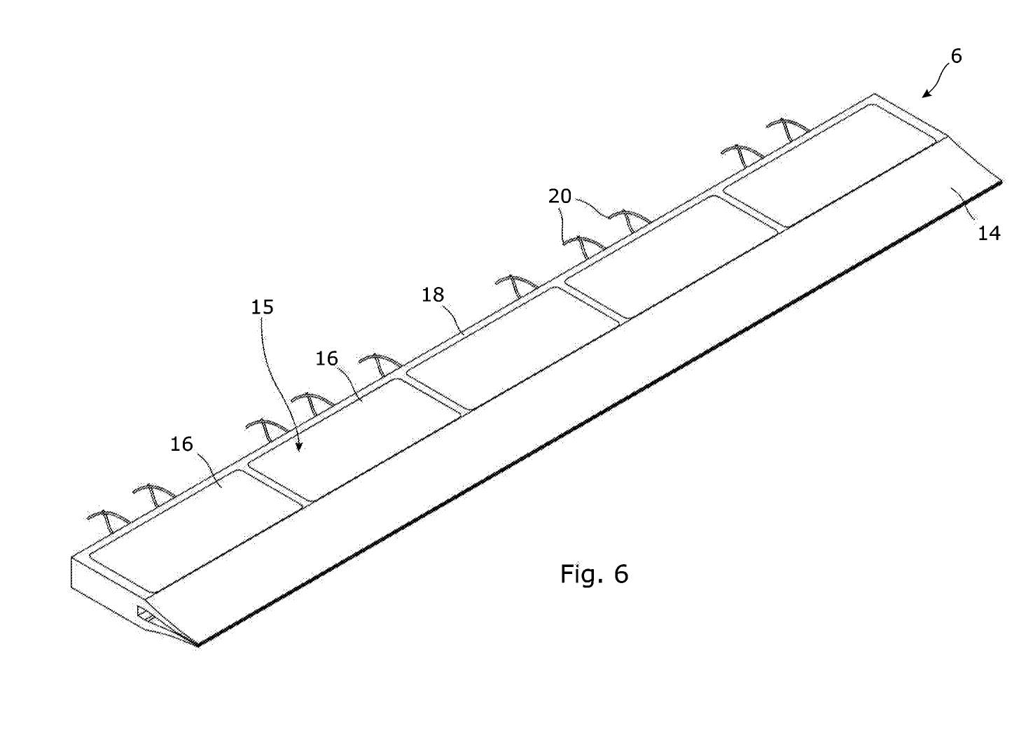

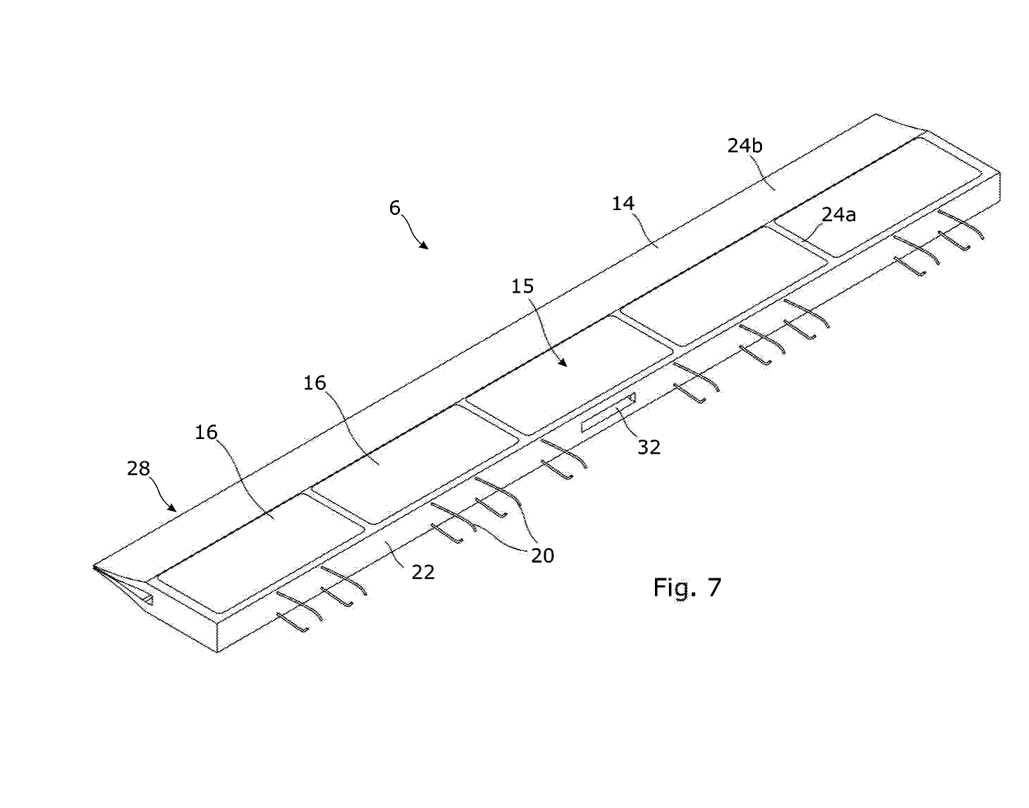

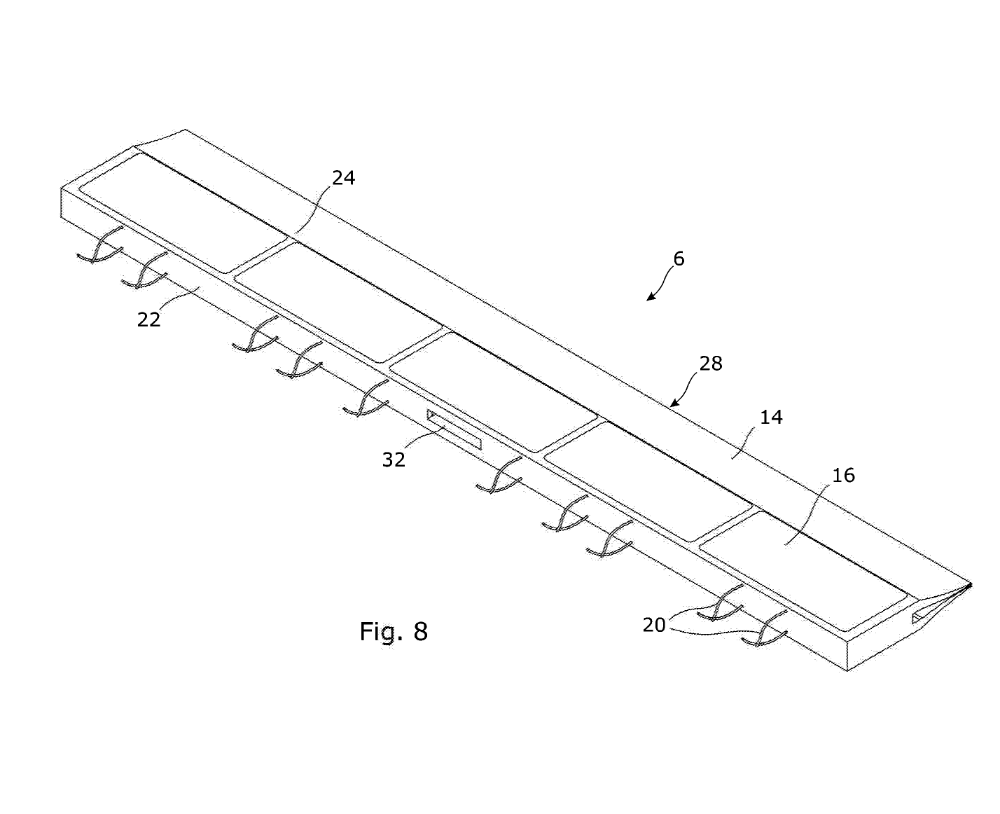

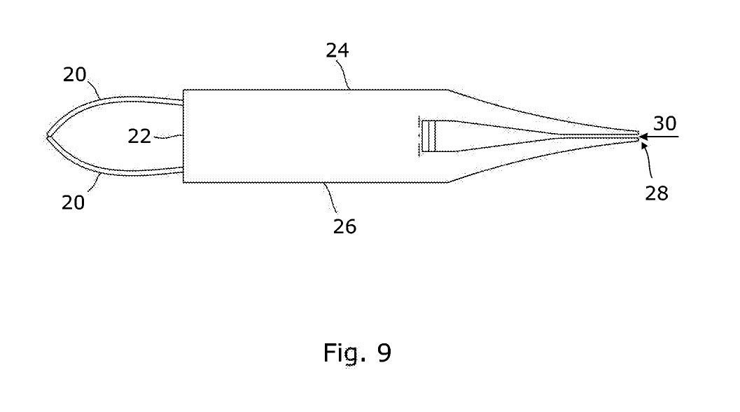

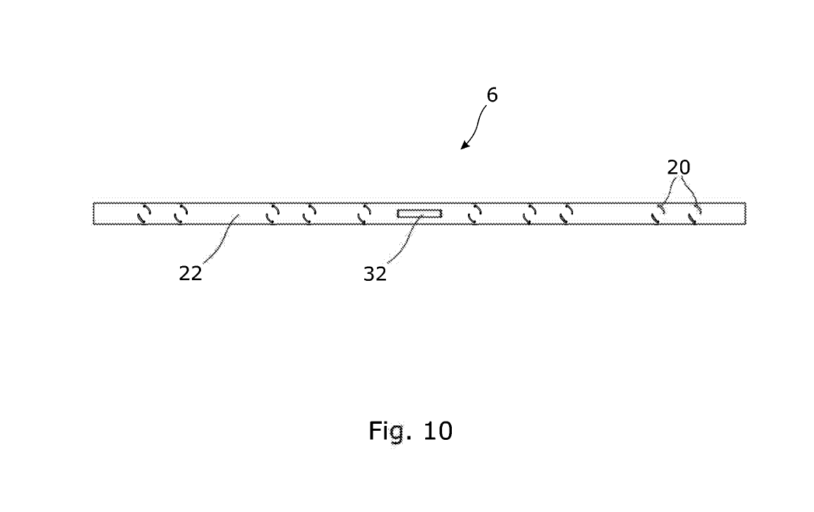

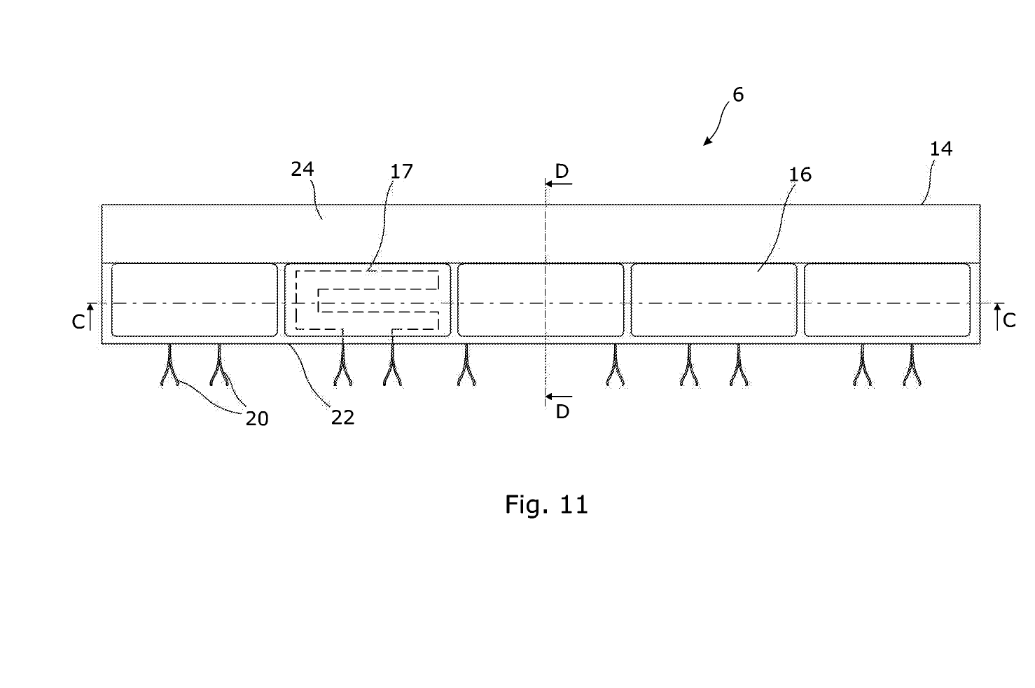

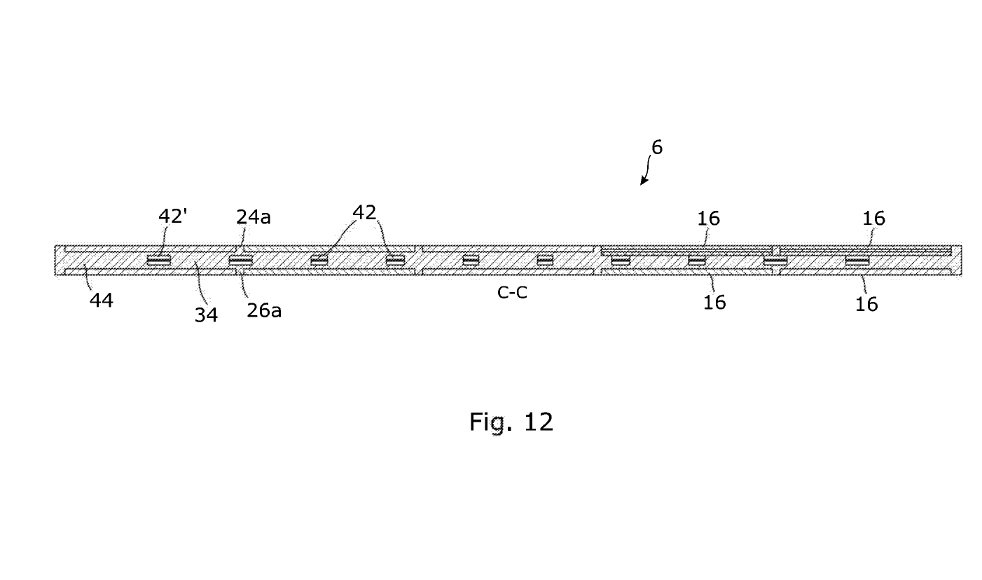

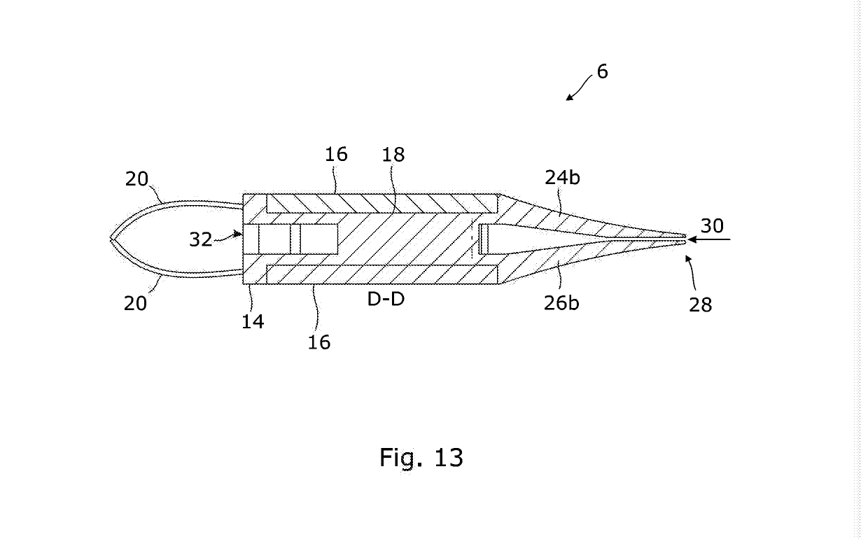

The caster tip 6 is shown in more detail in FIGS. 6-14. The caster tip 6 comprises a caster tip body 14 and an electrical resistance heater 15 comprising a plurality of heater panels 16 that are mounted in thermal contact with the body 14. In this embodiment the caster tip 6 includes ten heater panels 16, five of these heater panels 16 being positioned against an upper face of the body 14 and the other five heater panels 16 being positioned against a lower face of the body 14. It should be understood however that the caster tip 6 could include more or fewer heater panels 16: for example it could include 1, 2, 3, 4, 5, 6, 7, 8, 9, 10, 11 or 12 panels, or more. Also, although the heater panels in this embodiment are approximately rectangular in shape, they may alternatively have any other suitable shape.

The electric resistance heater 15 preferably covers a substantial portion of the area of the upper and lower surfaces of the caster tip body, typically about 50% of the area. The electric resistance heater 15 also preferably extends across substantially the entire width W of the caster tip body, in this example across about 95% of the width. This ensures even heating of the caster tip body.

Each of the heater panels 16 is located within a corresponding recess 18 in the respective face of the caster tip body 14. Preferably, each recess 18 and the corresponding heater panel 16 have similar shapes so that the heater panel 16 fits closely within the recess 18. If required, the heater panel 16 may be secured within the recess 18 by any suitable means: for example it may be secured by a layer of cement or adhesive between the heater panel 16 and the body 14, or the heater panel 16 may have a tight fit within the recess 18 so that it is retained by mechanical interference, or it may be retained by a mechanical fixing element, for example a clamp or bolt. In some circumstances the heater panels may be designed to be removable, allowing them re-used if it is necessary to replace the caster tip body 14.

Each heater panel 16 includes an electrical resistance heater element 17 that is embedded within a low density ceramic or non-ceramic fibre board. The fibre board may for example be made from a refractory ceramic fibre (RCF) material, for example alumina silicate fibre board such as Ceraboard 100, or it may be made from a bio-soluble non-RCF material, for example Superwool HT Fibre C Board. Each heater panel 16 includes a set of electrical connection wires 20 that extend outwards from the panel 16. These connection wires 20 allow the heating element 17 to be connected to an electrical supply to supply power to the heating element. Each heater panel 16 may also include a sensor (not shown), for example a thermocouple, for sensing the temperature of the heater panel. The sensor may be connected to a control unit (not shown) that controls the supply of power to the heater panel in order to maintain the heater panel at a predetermined temperature.

The caster tip body 14 has a hollow box-like structure comprising a rear wall 22, a top plate 24 and a bottom plate 26. The top plate 24 includes a rear portion 24a that is connected to the rear wall 22, and a front portion 24b that extends from the rear portion 24a towards the front edge 28 of the caster tip body 14. Similarly, the bottom plate 26 includes a rear portion 26a that is connected to the rear wall 22, and a front portion 26b that extends from the rear portion 26a towards the front edge 28 of the caster tip body 14. In this embodiment the rear portions 24a, 26a of the top and bottom plates are substantially parallel to each other and the front portions 24b, 26b converge towards one another to provide a narrow feed slot 30 (typically with a width in the range of about 6-10 mm) through which liquid metal is fed into the nip 12 between the lower and upper rolls 4a, 4b. Preferably, the outer surfaces of the front portions 24b, 26b are radiused to match approximately the curvature of the rolls 4a, 4b, so that the feed slot 30 can be positioned close to the nip 12. An inlet port 32 is provided in the rear wall 22 allowing liquid metal to be introduced into the hollow interior of the caster tip body 14.

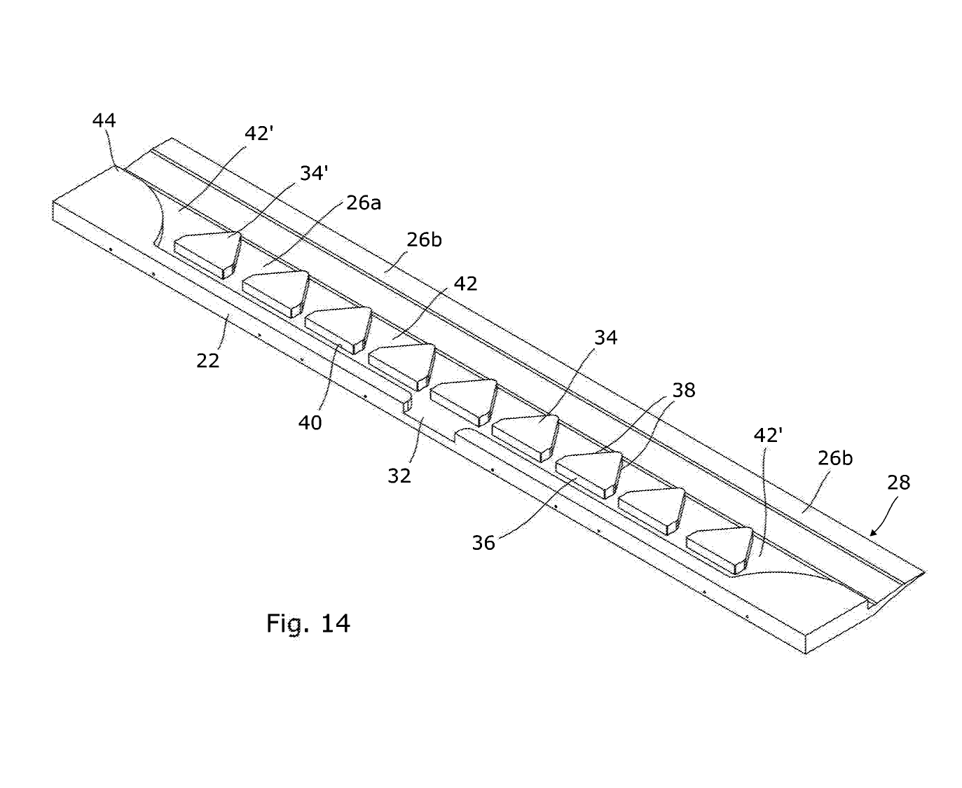

In FIG. 14 the caster tip body 14 is shown with the top plate 24 removed to reveal the interior structure of the body. A plurality of baffles 34 are provided within the caster tip body 14 to guide the flow of liquid metal between the inlet port 32 and the feed slot 30. Each baffle 34 is substantially triangular in shape, having a wide base 36 that faces the rear wall 22, and a pair of side walls 38 that converge towards the front edge 28 of the body 14. The baffles 34 extend between and are connected to the rear portions 24a, 26a of the top and bottom plates and provide a transverse flow channel 40 that extends lengthwise across the body 14 between the rear wall 22 and the bases 36 of the baffles and a plurality of longitudinal flow channels 42 between the side walls 36 of adjacent baffles 34. Two additional longitudinal flow channels 42′ are provided between the endmost baffles 34′ and a pair of curved buttress elements 44, which are located at the ends of the caster tip body 14 and extend forwards from the rear wall 22 towards the front edge 28.

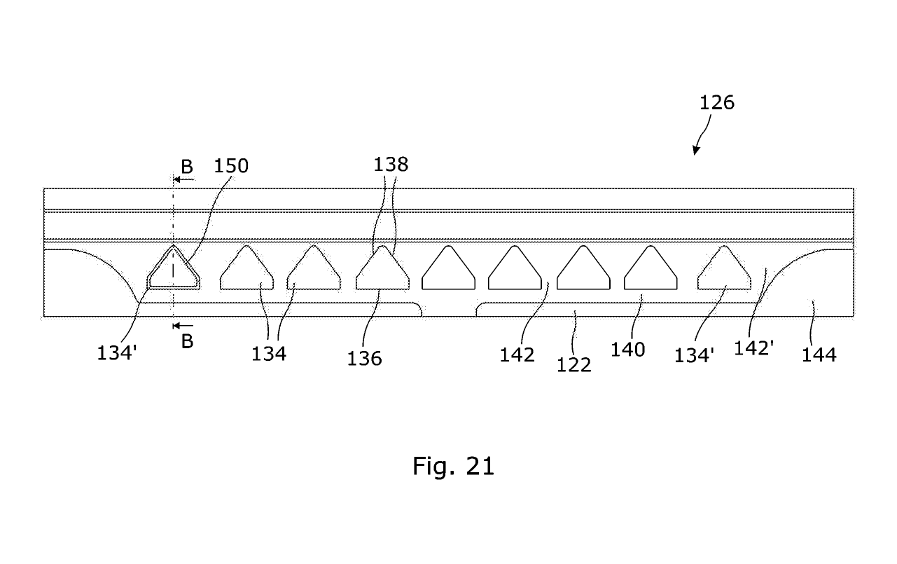

Optionally, thermally conductive inserts may be provided in one or more of the baffles 34, 34′, which may be similar to the inserts 150 described below in relation to the second embodiment of the invention as shown in FIGS. 21 & 22.

In use, the caster tip 6 is preheated to a selected temperature, usually in the range 680-750 C, by supplying electric current to the heater panels 16. Preferably, the temperature of the caster tip is controlled by a control unit (not shown) that adjusts the power delivered to the heater panels 16 to maintain the caster tip at a selected predetermined temperature. The control unit (not shown) may be connected to a temperature sensor, for example a thermocouple, which senses the temperature of the caster tip.

Liquid metal is introduced into the hollow interior of the caster tip body 14 through the inlet port 32. The liquid metal flows outwards along the transverse flow channel 40 and then flows forwards through the longitudinal flow channels 42, 42′ so that it is directed evenly to the feed slot 30 at the front edge 28 of the caster tip body 14.

The caster tip body 14 is preferably formed as a single monolithic casting, preferably from a ceramic material with a medium to high thermal conductivity. The ceramic material with thermal conductivity accelerants preferably has a thermal conductivity in the range 0.1-30 W/mK, preferably 1-20 W/mK, more preferably 1-15 W/mK.

The use of a single monolithic casting means that the caster tip body 14 is formed as a single piece including the top and bottom plates and the internal baffle structure. This product provides a number of advantages in that no assembly is required, and the strength of the product is also increased. There are no internal joints from which leakage can occur.

The ceramic material may for example be based on fused silica. In one preferred form of the invention the top plate and the bottom plate are made from a castable refractory material that includes fused silica, ceramic fibre, microsilica and a bonding material comprising colloidal silica. The castable refractory material is strong and has good resistance to erosion from liquid aluminium and aluminium alloys, good thermal shock resistance, low thermal conductivity and good dimensional stability. It is castable, thus simplifying the production of refractory products in a range of different shapes. It can also be machined, allowing products to be made to very fine tolerances. The ceramic fibre contained within the material plays an important role in dispersing thermal and mechanical stresses within the cast product, thereby increasing the strength and thermal shock resistance of the product. The term “ceramic fibre” as used herein is intended to include both crystalline ceramic fibres and amorphous ceramic fibres (vitreous or glass fibres). The ceramic fibre may for example be an alkaline earth silicate fibre or an alumino silicate fibre.

The three forms of silica (fused silica, microsilica and colloidal silica) contained within the castable refractory material ensure a near ideal packing density, thereby increasing the strength of the cast product. The fused silica generally comprises a range of particle sizes, for example from 3.5 μm to 150 μm, or for some products up to 6 mm. The microsilica generally has a smaller particle size, for example around 1 μm, and the particles are approximately spherical. This ensuring good packing density, provides a large surface area for a good bond strength, and helps the material to flow thereby reducing the water demand. The colloidal silica comprises nanoparticles of silica, for example between 1 and 100 nanometres in size, which fill the interstices between the larger particles and provide great bond strength in the fired product.

The ceramic fibre is preferably soluble (non-durable) in physiological fluids (this type of fibre is sometimes called a “non-RCF fibre”): for example it may be an alkaline earth silicate fibre. However it may alternatively be a non-soluble refractory ceramic fibre, for example an alumino silicate wool fibre.

Alternatively, the top and bottom plates may be made from a cement-bonded fused silica refractory material, or a silicon carbide (SiC) based material, or a material that is based on a combination of fused silica and SiC. Optionally, the material may be modified by the addition of Si₃N₄ or Magnesium Oxide (MgO) powder for increased thermal conductivity, typically at a dosage rate of up to 35 wt % of the body. This can increase the thermal conductivity of the body to the desired range of 1-15 W/mK.

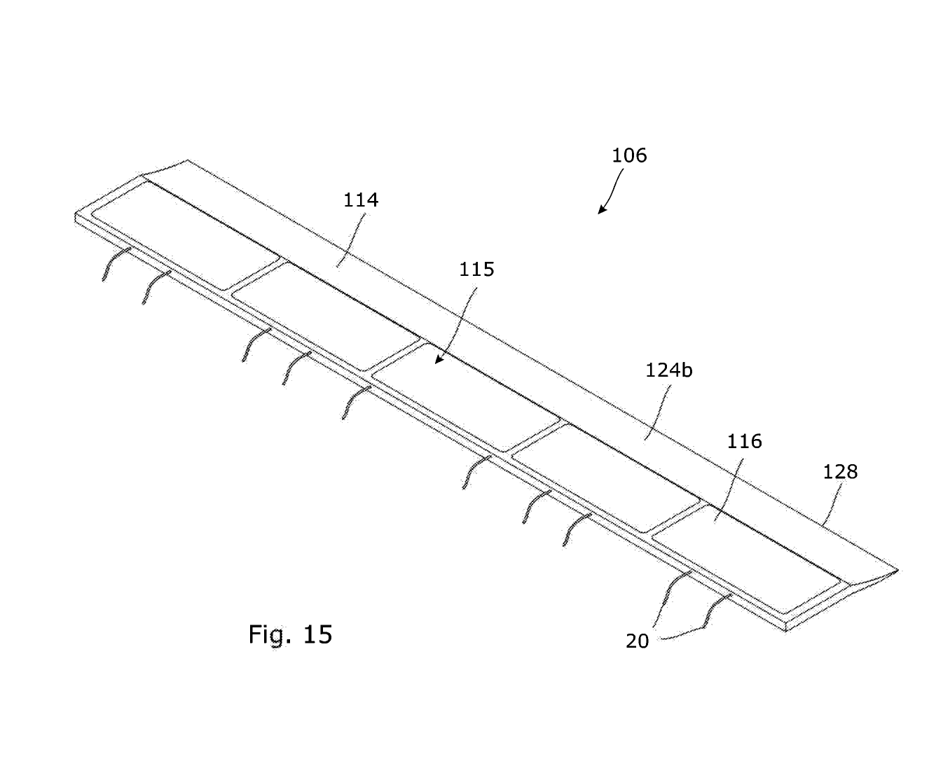

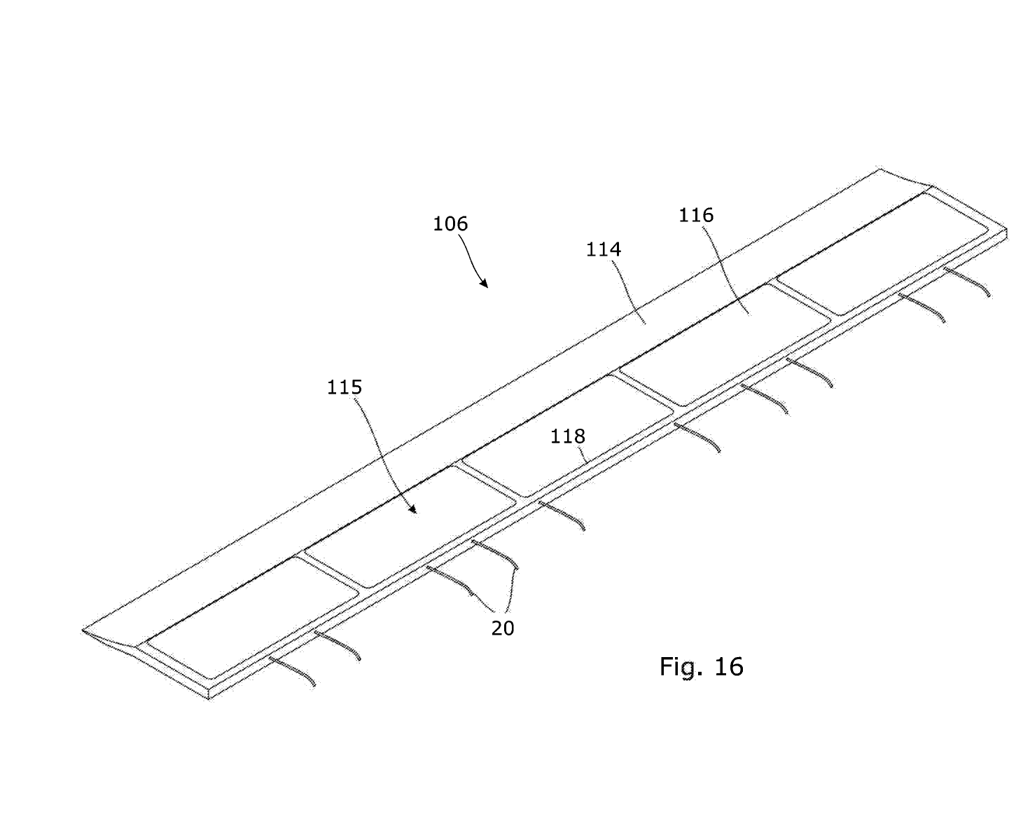

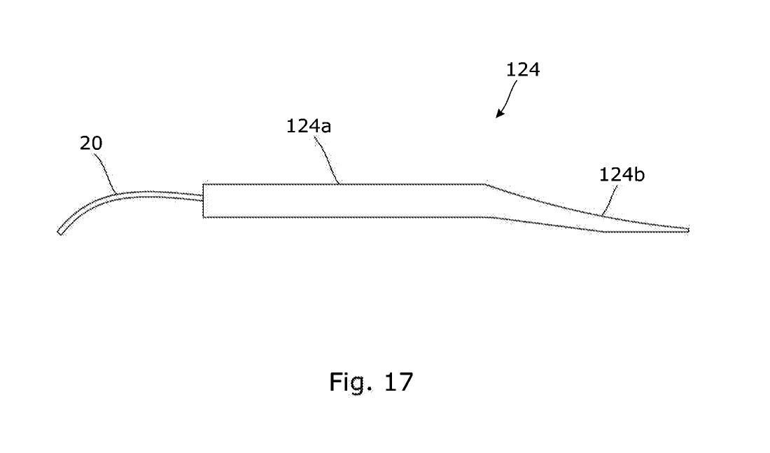

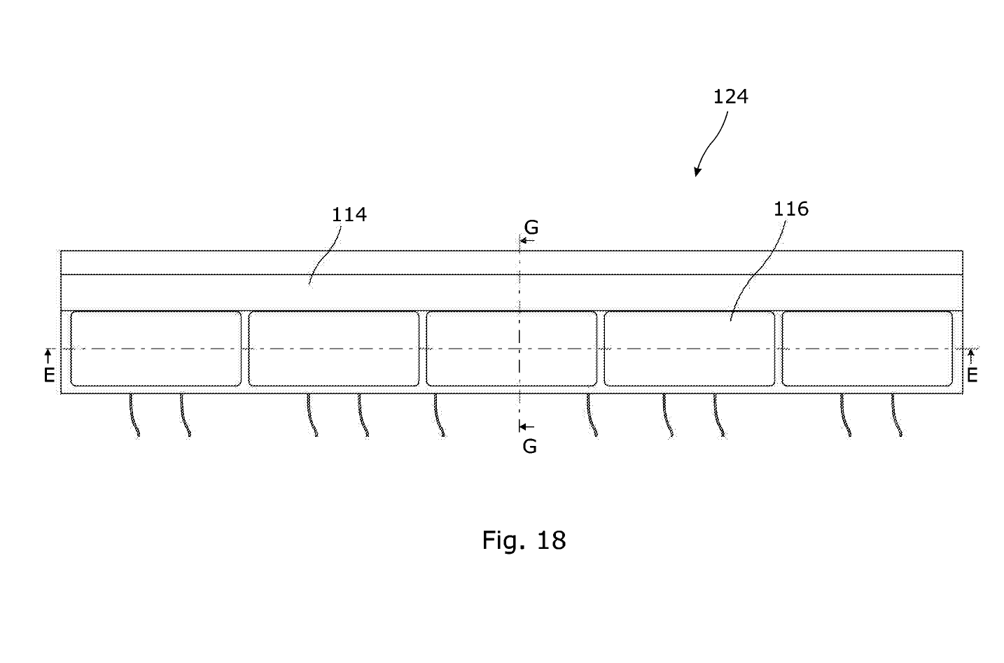

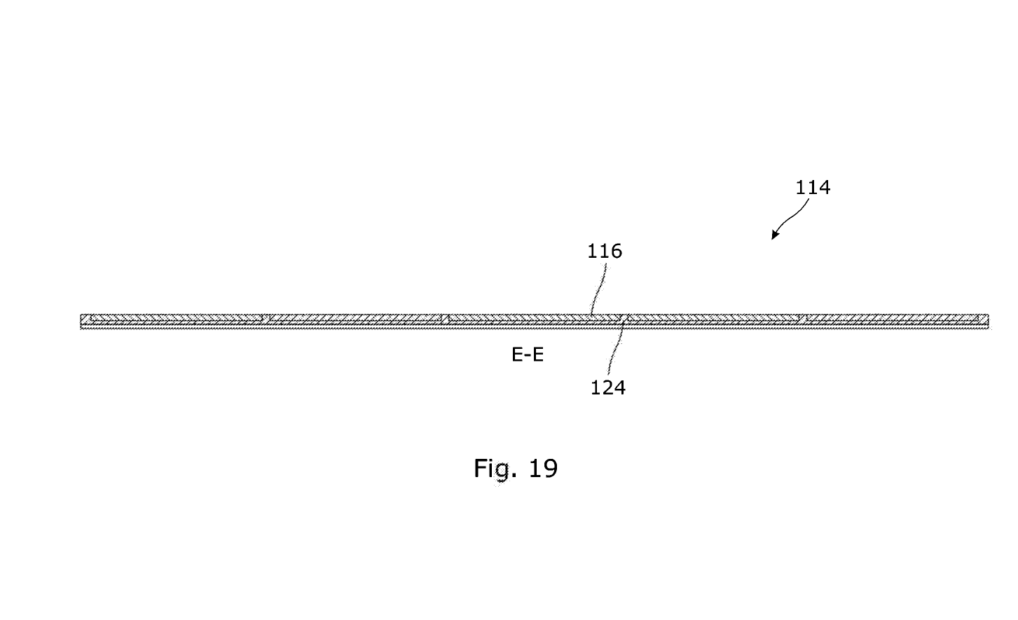

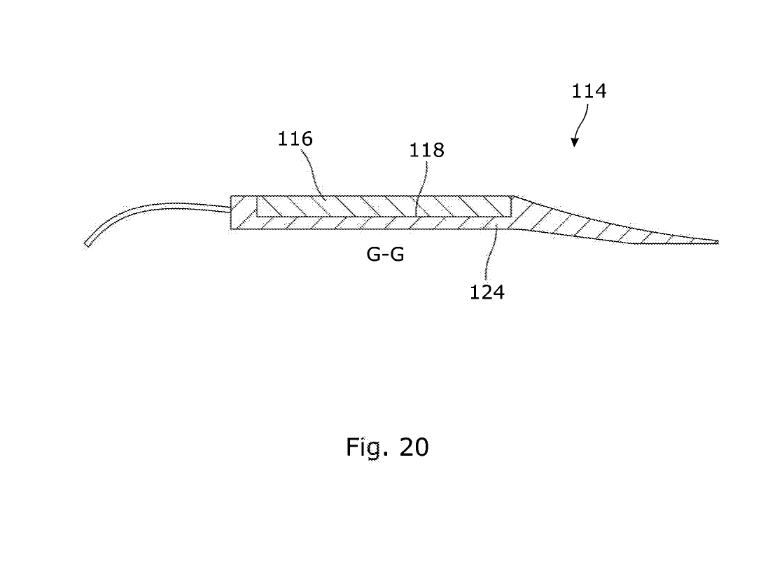

A second caster tip 106 according to an embodiment of the invention is shown in FIGS. 15-22. The second caster tip 106 comprises a caster tip body assembly 114 and an electrical resistance heater 115 comprising a plurality of heater panels 116 that are mounted in thermal contact with the body assembly 114. In this embodiment the caster tip 106 includes ten heater panels 116, five of the heater panels being positioned against an upper face of the body assembly 114 and the other five heater panels 116 being positioned against a lower face of the body assembly 114. It should be understood however that the caster tip 106 could include more or fewer heater panels 116: for example it could include between one and twelve heater panels, or possibly more. Also, although the heater panels 116 in this embodiment are approximately rectangular in shape, they may alternatively have any other suitable shape.

The electric resistance heater 115 preferably covers a substantial portion of the area of the upper and lower surfaces of the caster tip body, typically about 50% of the area. The electric resistance heater 115 also preferably extends across substantially the entire width W of the caster tip body, in this example across about 95% of the width. This ensures even heating of the caster tip body.

Each of the heater panels 116 is located within a corresponding recess 118 in the respective face of the caster tip body assembly 114. Preferably, each recess 118 and the corresponding heater panel 116 have similar shapes so that the heater panel 116 fits closely within the recess. If required, the heater panel 116 may be secured within the recess by any suitable means: for example it may be secured by a layer of cement or adhesive between the heater panel 116 and the body assembly 114, or the heater panel 116 may have a tight fit within the recess 118 so that it is retained by mechanical interference, or it may be retained by a mechanical fixing element, for example by a clamp or bolt.

Each heater panel 116 includes an electrical resistance heater that is embedded within a low density ceramic or non-ceramic fibre board. The heater panels may for example be similar to the heater panels 16 of the first caster tip 6 that is shown in FIGS. 6-14 and is described above.

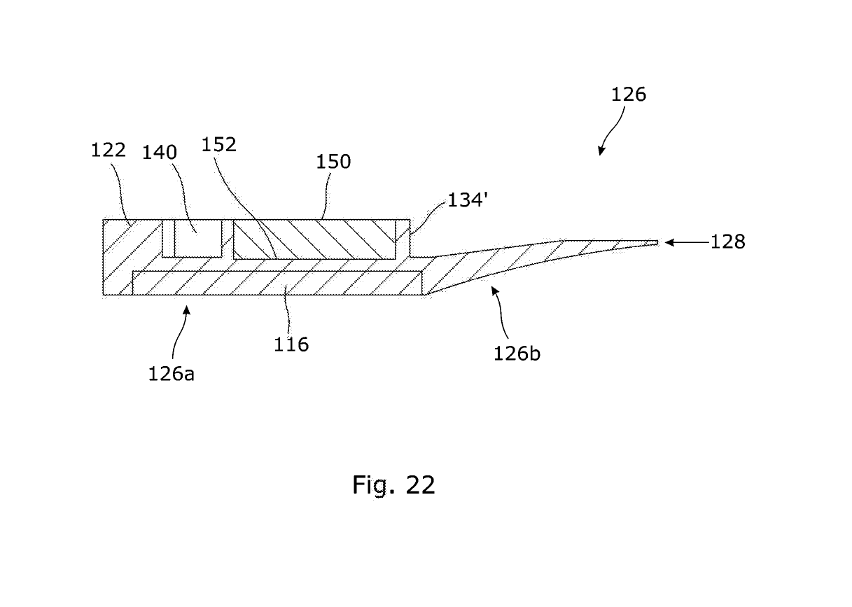

The caster tip body assembly 114 has a hollow box-like structure and comprises a top plate 124 and a separate bottom plate 126. The top plate 124, which is shown in FIGS. 15-20, includes a rear portion 124a and a front portion 124b that extends from the rear portion 124a towards the front edge 128 of the body assembly 114. The bottom plate 126, which is shown in FIGS. 21-22, includes a rear portion 126a and a front portion 126b that extends from the rear portion 126a towards the front edge 128 of the body assembly 114. In the assembled caster tip 106 the rear portions 124a, 126a of the top and bottom plates are substantially parallel to each other and the front portions 124a, 126b converge towards one another to provide a narrow feed slot 130 through which liquid metal is fed into the nip 12 between the lower and upper rolls 4a, 4b. Preferably, the outer surfaces of the front portions 124b, 126b are radiused to match approximately the curvature of the rolls, so that the feed slot 130 can be positioned close to the nip 12.

As shown in FIGS. 21 and 22, the bottom plate 126 includes in this embodiment a rear wall 122 and a plurality of baffles 134 that guide the flow of liquid metal between an inlet port 132 in the rear wall 122 and the feed slot 130. Each baffle 134 is substantially triangular in shape, having a wide base 136 and a pair of side walls 138 that converge towards the front edge 128 of the body assembly 114. The baffles 134 extend upwards from the rear portion 126a of the bottom plate 126 towards the rear portion 124a of the top plate 126. The baffles 134 provide a transverse flow channel 140 that extends lengthwise across the body assembly 114 between the rear wall 122 and the bases 136 of the baffles, and a plurality of longitudinal flow channels 142 between the side walls 138 of adjacent baffles 134. Two additional longitudinal flow channels 142′ are provided between the endmost baffles 134′ and a pair of curved buttress elements 144, which are located at the ends of the bottom plate 126 and extend forwards from the rear wall 122 towards the front edge 128.

In use, the caster tip 106 is preheated to a selected temperature, usually in the range 650-750 C, by supplying electric current to the heater panels 16. Preferably, the temperature of the caster tip is controlled by a control unit (not shown) that adjusts the power delivered to the heater panels 116 to maintain the caster tip at a selected predetermined temperature. The control unit (not shown) may be connected to a temperature sensor, for example a thermocouple, which senses the temperature of the caster tip. Liquid metal is introduced into the hollow interior of the body assembly 114 through the inlet port 132. The liquid metal flows outwards along the transverse flow channel 140 and then forwards through the longitudinal flow channels 142, 142′ so that it is distributed evenly to the feed slot 130 at the front edge 128 of the body assembly 114.

In this embodiment the top plate 124 and the bottom plate 126 are each formed as separate monolithic castings, preferably from a ceramic material with low thermal conductivity. The ceramic material preferably has a thermal conductivity in the range 0.1-30 W/mK, preferably 1-20 W/mK, more preferably 1-15 W/mK.

The ceramic material may for example be based on fused silica. The ceramic material may be a fibrous ceramic material. In one preferred form of the invention the top plate and the bottom plate are made from a castable refractory material that includes fused silica, ceramic fibre, microsilica and a bonding material comprising colloidal silica, as described above. Alternatively, the top and bottom plates may be made from a conventional cement-bonded fused silica refractory material or a silicon carbide (SiC) based material or a material that is based on a combination of fused silica and SiC. Optionally, the material may be modified by the addition of Si₃N₄ or MgO powder, preferably at a dosage rate of up to 35 wt %. In the assembled caster, the top plate 124 and the bottom plate 126 are attached to one another to form the caster tip assembly 106.

In the second embodiment described above the baffles 134 are part of the bottom plate 126. Alternatively, the baffles may be formed separately as individual components or a baffle structure, which is fitted between the top plate and the bottom plate in the assembled caster tip. Similarly, the rear wall 122 may form part of the bottom plate 126 as in the second embodiment described above, or it may form a separate component that is located between the top plate 124 and the bottom plate 126 in the assembled caster tip. The rear wall 126 and the baffle structure then maintain a separation between the top plate 124 and the bottom plate 126.

The baffle structure is preferably made of a thermally insulating ceramic material. Optionally however each individual baffle may include a thermally-conductive core to increase the transfer of energy between the heater panels 116 and the liquid metal contained within the caster tip. This is illustrated in FIGS. 21 and 22, where the left-hand baffle 134′ in FIG. 21 includes an optional thermally-conductive insert 150, which has a higher thermal conductivity than the ceramic material of the baffle structure and/or the body of the caster tip. It should be understood that each of the other baffles 134, 134′ may also optionally include a thermally-conductive insert 150. The thermally-conductive inserts 150 may for example be made of graphite or another suitable high conductivity material having a thermal conductivity of at least 1 W/mK, preferably at least 5 W/mK, more preferably at least 8 W/mK. The insert 150 is positioned within a recess 152 of the baffle 134, 134′ and is completely surrounded by the material of the baffle so that it does not come into contact with the liquid metal held within the hollow body of the caster tip 106. It is therefore protected against corrosion from contact with the liquid metal.

Similar thermally-conductive inserts may be provided in one or more of the baffles 34, 34′ in the first caster tip described above and shown in FIGS. 1-14.

The thermal conductivity of the ceramic material used for the caster tip body may also be increased in the vicinity of the heater panels in various other ways. For example, the thermal conductivity may be increased by including a greater proportion of a high thermal conductivity material such as silicon carbide in selected regions of the caster tip body, for example in the rear portions 24a, 26a, 124a, 126a of the top and bottom plates, which are close to the positions of the heater panels. By comparison, a smaller proportion of the high thermal conductivity material can be included in the front portions 24b, 26b, 124b, 126b of the top and bottom plates, which are further from the heater panels. It is also possible to use a progressive material: i.e. one in which the thermal conductivity varies gradually in different regions of the caster tip body.

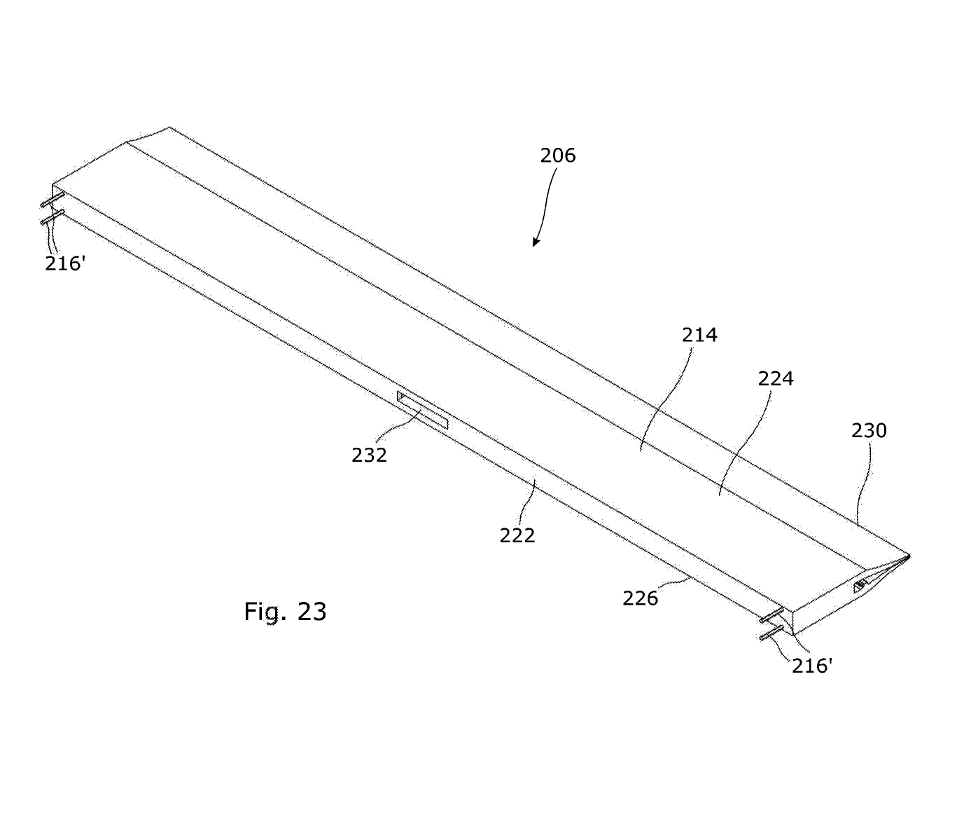

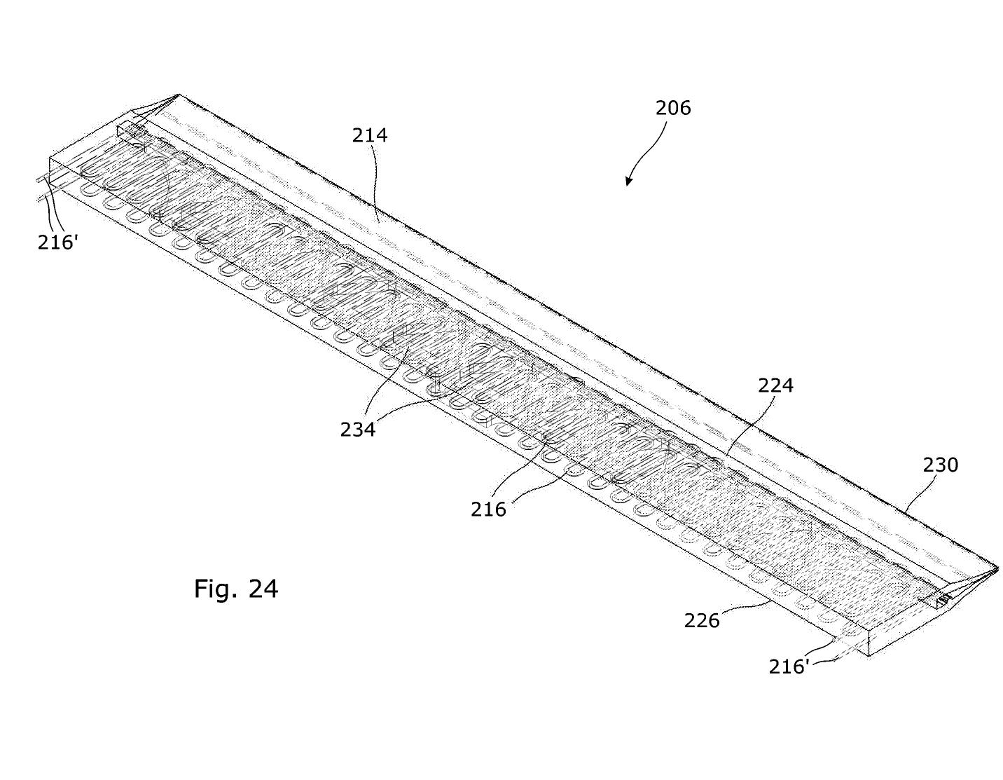

A third caster tip 206 according to the invention is shown in FIGS. 23 and 24. The caster tip 206 comprises a caster tip body 214 and a pair of electrical heater elements 216 that are embedded within the body 214, in thermal contact with the body. One of the heater elements 216 is embedded within the rear part of the top plate 224 and the other is embedded within the rear part of the bottom plate 226. Each heater element 216 extends from one end of the caster tip to the other and follows a tortuous path, so that in use the entire rear part of the caster tip body 214 can be heated.

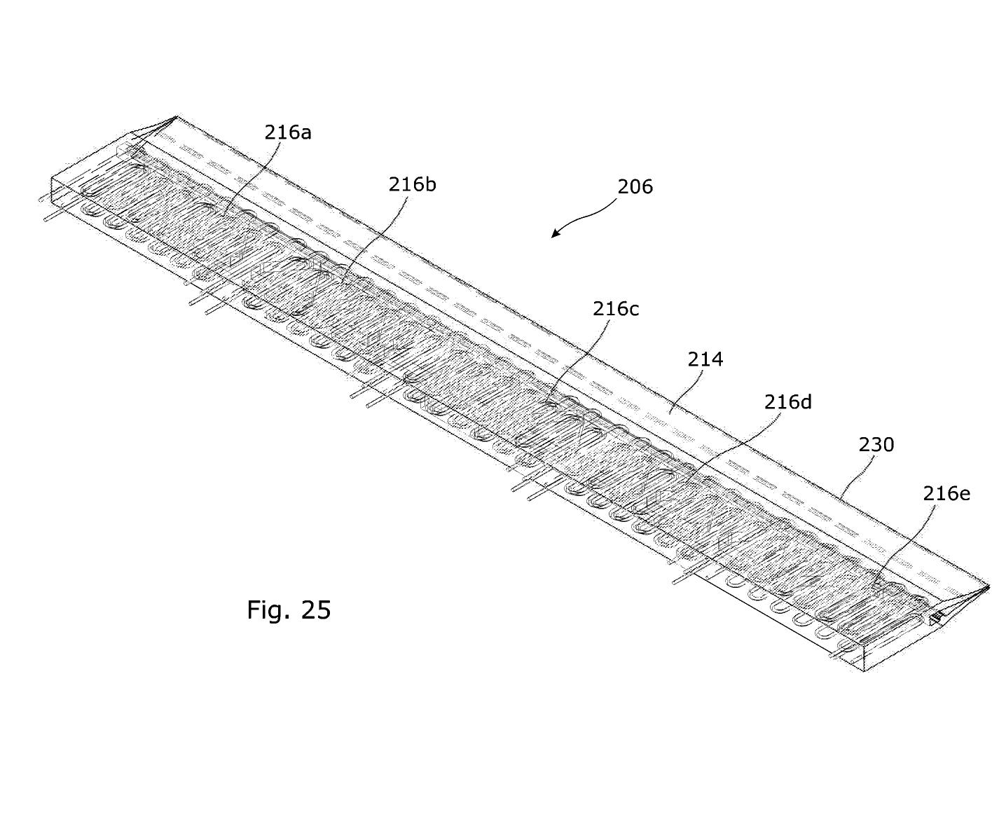

A modified form of the third caster tip is shown in FIG. 25. This is identical to the third caster tip 206 shown in FIGS. 23 and 24, except that each of the electrical heater elements 216 is replaced by multiple separate heating elements 216a-e that are spaced along the length of the caster tip to provide different temperature heating conditions in different zones of the caster tip.

Where direct contact is made between the heating element and the caster tip care is taken to ensure the heating element is electrically insulated. This can be done by either placing the heating element within a protective electrical insulating case or embedding the heating element with an electrical insulation barrier such as Magnesium Oxide (MgO). The heater element(s) are therefore electrically isolated from the caster tip at all times.

The caster tips 206 shown in FIGS. 23, 24 and 25 may be made, for example, by placing the heating elements 216a-e in a mould and then casting the ceramic material of the caster tip body 214 around the heater elements. Terminal portions 216′ of the heater elements extend rearwards through the rear wall of the caster tip body, allowing the heater elements to be connected to an electrical power supply.

In these embodiments, the caster tip body 214 comprises a single monolithic casting that has a hollow box-like structure and comprises a top plate 224, a bottom plate 226, a rear wall 222 and a plurality of internal baffles 234 that guide the flow of liquid metal between an inlet port 232 in the rear wall 222 and the feed slot 230. Structurally, the caster tip body is similar to the first caster tip described above. Alternatively, the caster tip 206 may include a caster tip body assembly, comprising an assembly of separate components similar to the second caster tip described above.

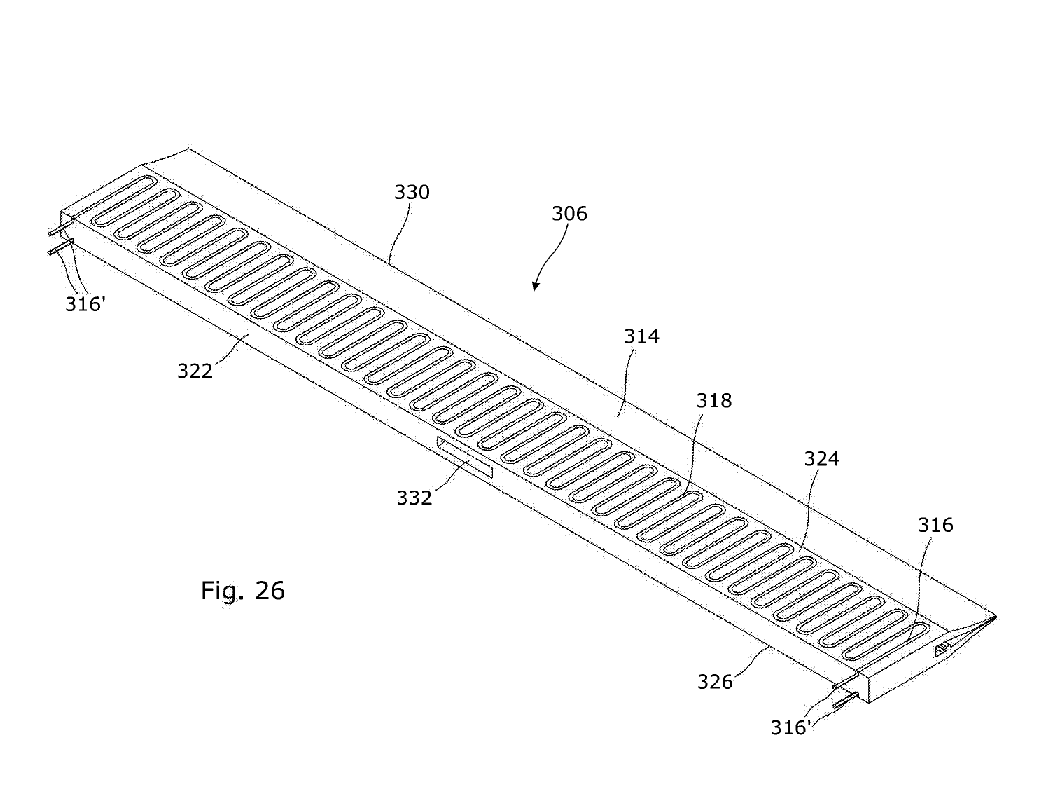

A fourth caster tip 306 according to the invention is shown in FIG. 26. The fourth caster tip 306 comprises a caster tip body 314 and a pair of electrical heater elements 316 that are accommodated within grooves 318 provided in the upper and lower faces of the caster tip body 314. The heater elements 316 are therefore mounted in thermal contact with the body 314. One of the heater elements 316 is accommodated within a groove 318 in the rear part of the top plate 324 and the other is accommodated within a groove in the rear part of the bottom plate 326.

Each groove 318 and therefore each heater element 316 extends from one end of the caster tip to the other and follows a tortuous path, so that in use the entire rear part of the caster tip body 314 can be heated.

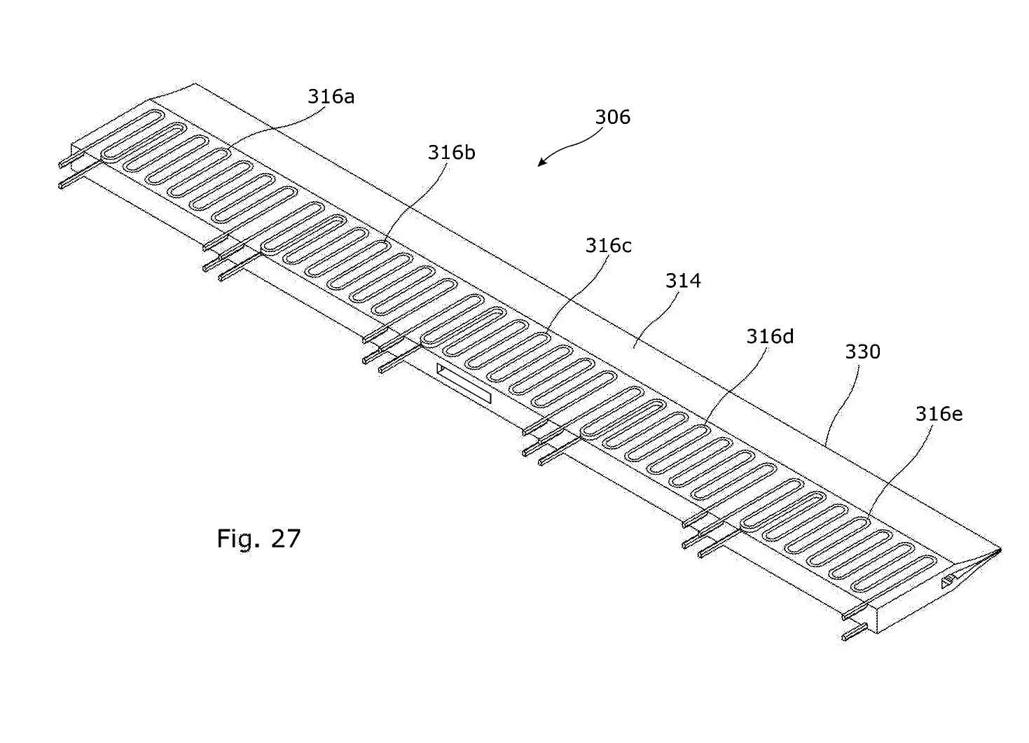

A modified form of the fourth caster tip is shown in FIG. 27. This is identical to the fourth caster tip 306 shown in FIG. 26, except that each of the electrical heater elements 316 is replaced by multiple separate heating elements 316a-e that are spaced along the length of the caster tip to provide different temperature heating conditions in different zones of the caster tip.

The caster tips 306 shown in FIGS. 26 and 27 may be made, for example, by casting the ceramic material to form the caster tip body 314 including a moulded groove 318, locating a heater element in the groove and then filling the groove with either a thin electrically-insulating refractory material, or an electrical insulating paste. Terminal portions 316′ of the heater elements extend rearwards through the rear wall of the caster tip body, allowing the heater elements to be connected to an electrical power supply.

In these embodiments, the caster tip body 314 comprises a single monolithic casting that has a hollow box-like structure and comprises a top plate 324, a bottom plate 326, a rear wall 322 and a plurality of internal baffles (not shown) that guide the flow of liquid metal between an inlet port 332 in the rear wall 322 and the feed slot 330. Structurally, the caster tip body is similar to the first caster tip described above. Alternatively, the caster tip 306 may include a caster tip body assembly, comprising an assembly of separate components similar to the second caster tip described above, and either a single heater element per caster tip or multiple elements

What is claimed is:

1. A caster tip for a continuous strip caster for non-ferrous metals, wherein the caster tip comprises a caster tip body made primarily of a ceramic material, and an electric resistance heater thermally connected to the caster tip body for pre-heating the caster tip body to a predetermined temperature.

2. The caster tip according to claim 1, wherein the caster tip body has an upper surface and a lower surface, and the electric resistance heater is located on and in thermal contact with at least one of the upper and lower surfaces.

3. The caster tip according to claim 2, wherein the electric resistance heater covers at least 30% of the area of said upper and/or lower surface.

4. The caster tip according to claim 1, wherein the caster tip body has a width and the electric resistance heater extends across substantially the entire width of the caster tip body.

5. The caster tip according to claim 1, wherein the electric resistance heater comprises at least one heater panel that includes an electric heating element embedded in a support panel.

6. The caster tip according to claim 5, wherein the support panel comprises a ceramic fibre board or a non-ceramic fiber board.

7. The caster tip according to claim 5, wherein the caster tip body includes at least one recess that receives a heater panel.

8. The caster tip according to claim 1, wherein the electric resistance heater comprises at least one electric heating element that is embedded within the ceramic material of the caster tip body.

9. The caster tip according to claim 1, wherein the electric resistance heater comprises at least one electric heating element that is accommodated within a groove formed in a surface of the caster tip body.

10. The caster tip according to claim 1, wherein the caster tip body made primarily of a ceramic material that includes fused silica.

11. The caster tip according to claim 1, wherein the caster tip body made of a ceramic material that includes fused silica, ceramic fibre, microsilica and a bonding material comprising colloidal silica.

12. The caster tip according to claim 1, wherein the caster tip body is made of a ceramic material that has a thermal conductivity at a temperature of 700° C. in the range of 0.1-30 W/mK.

13. The caster tip according to claim 1, wherein the caster tip body includes at least one thermal conductor element having a thermal conductivity greater than that of the ceramic material.

14. The caster tip according to claim 1, wherein the caster tip is used in casting aluminium, wherein the predetermined temperature is in a range of 600-750° C.

15. The caster tip according to claim 1, wherein the caster tip body comprises a top plate and a bottom plate, and the top and bottom plates are spaced from one another to provide a feed slot for liquid metal at a front edge of the caster tip body, and an inlet port for liquid metal at a rear end of the caster tip body.

16. The caster tip according to claim 15, further including a baffle structure between the top and bottom plates for distributing a flow of liquid metal from the inlet port to the feed slot.

17. The caster tip according to claim 15, wherein the front edge of the castor tip body is tapered to fit between a pair of counter-rotating rolls in a twin roll caster.

18. The caster tip according to claim 15, wherein the caster tip body comprises a monolithic cast structure that includes the top plate, the bottom plate and the baffle structure.

19. The caster tip according to claim 15, wherein the caster tip body comprises an assembly of separate cast structures including the top plate and the bottom plate, and optionally the baffle structure.

20. A continuous strip caster for non-ferrous metals, the strip caster including a pair of counter-rotating casting elements and the caster tip according to claim 1, wherein the caster tip is located adjacent a nip between the casting elements and is configured to feed liquid metal into the nip to form a cast strip of metal.

21. The continuous strip caster according to claim 20, wherein the counter-rotating casting elements comprise a pair of counter-rotating rolls, and wherein the caster tip is located adjacent a nip between the rolls.
